(19) United States
(12) Patent Application Publication
(10) Pub. No.: US 2004/0207862 A1
(43) Pub. Date: Oct. 21, 2004

(54) Automatic triggering of a closed loop color calibration in printer device

(76) Inventors: Alberto Such, Barcelona (ES); Andres Gonzalez, Barcelona (ES); Manuel Gonzalez, Barcelona (ES)

Correspondence Address: HEWLETT PACKARD COMPANY, Intellectual Property Administration, P.O. Box 272400, Fort Collins, CO, 80528-9599, US

(21) Appl. No.: 09/946,024

(22) Filed: Sep. 4, 2001

(51) Int. Cl. G06F 15/00; H04N 1/00

(52) U.S. Cl. 358/1.9; 358/406; 358/518

(57) ABSTRACT

There is disclosed a format used in a remote proofing system to ensure that a printer device to which a print job is sent, operates within pre-determined calibration criteria for printing an image. Each job file has a job ticket, which defines a plurality of data types, which are to be checked for a printer device which is assigned to perform the printing. The parameters include ink level, environmental conditions (temperature, humidity), and media type. A printer device operates an algorithm to implement checks on the various parameters to determine whether a re-calibration process is required prior to printing an image. By sending a job file having no image data, a calibration of a printer can be achieved remotely, without necessarily printing an image.

### FIELD OF THE INVENTION

The present invention relates to printing, and particularly although not exclusively, to processing and printing of print jobs using an accurately calibrated printer device.

### BACKGROUND TO THE INVENTION

In the field of thermal inkjet printers, particularly but not exclusively of the large format type, exemplified by the Hewlett Packard DesignJet® products, there has been implemented in the prior art, a closed loop color method to ensure a correct and consistent behavior of the printers in terms of color rendition.

Referring to FIG. 1 there is illustrated schematically a prior art printer device 100 for printing large format print materials, the printer device 100 receiving print data containing information from which an image can be printed from a print source 101, typically a computer containing a graphics package. Typically, files of print data are sent from the print source 101 to the printer device 100 in a proprietary format. The printer device may have one or a plurality of print heads, and can accept a plurality of different media types and sizes. Further, the printer device experiences variations in environmental conditions, including variations in temperature and humidity. Changing the print heads, changing the media type, and changes in environmental conditions can alter the colors actually printed onto the print media, from a pre-determined expected nominal set of colors.

To correct for variations in color, prior art printers apply a closed loop color calibration method.

Referring to FIG. 2 herein, there is illustrated schematically prior art signal processing in a prior art printer device, for producing a calibrated corrected image. A target print head response 200 corresponding to an ideal print head response is either stored within the printer device as pre-stored data or defined analytically through an algorithm. An actual response characteristic 201 of the printer is measured by performing a calibration test. A calibration function 202 is applied to an image data 203 in calibration process 204, resulting in a modified image 205 which is then printed in a print process 206.

In prior art thermal inkjet printer products, the closed loop color method is performed in two steps as follows:

Firstly, a calibration operation is performed in order to measure a current color rendition characteristic of the printer. This calibration computes a deviation between a set of expected (nominal) colors and colors actually being printed.

Secondly, calibration values resulting from the calibration operation are used to modify color processing and rendering parameters within the printer to achieve a printer behavior, such that printing of the job is carried out within specified limits.

The calibration procedure needs to be performed every time there is a change in the printer configuration or environment which can have an impact on the color performance of the printer. Examples of such configuration or environment changes include:

changing one or several print heads;

changing a media type loaded onto the printer; and

changing of environmental condition such as temperature or humidity, with respect to those applicable at a time of a previous calibration.

In some prior art printers, calibration is triggered automatically when any one of the above events is detected. However other prior art printers leave the responsibility for re-calibration to a user, and a user has to manually trigger a calibration event, through the printer or through a driver user interface whenever the user determines the calculation of a new set of calibration values should take place.

However, the above calibration methods have a problem that it is not possible to ensure that a particular job is printed using the correct calibration values to achieve a consistent color. This is because there may not exist calibration values for the current printer conditions because there was an error in the calibration procedure. Errors in the calibration procedure can occur, for example because the user has deactivated the closed loop color calibration system completely, or in some cases where only manual triggering is implemented, because a user did not trigger the closed loop color calibration facility on a printer device.

Non use of the correct calibration results is a big problem when a best achievable color consistency is required to be printed, for example when a proof needs to be printed. Particularly, when using a printer in a remote proofing mode, where an originator of a proof does not have any control on the printer settings of a printer used to print a proof, and a color consistency of a print output can not be checked visually by the originator of a proof, ensuring accurate printer calibration is difficult.

To the best of the inventors knowledge, there are no prior art printer products which implement methods to automatically ensure that correct calibration values are used when processing a print job.

### SUMMARY OF THE INVENTION

According to a first aspect of the present invention there is provided a print job file comprising:

an image data field capable of containing image data describing an image; and

a job ticket field, comprising at least one setting flag for instructing whether a color calibration procedure is to be carried out or not.

According to a second aspect of the present invention there is provided a format for a print data file, said print data file comprising:

an image data content field, capable of containing data describing an image to be printed; and

a job ticket field, said job ticket field containing at least one printer parameter for of a printer device, said printer parameter selected from the set:

a media type parameter, describing a type of media that should be installed on said printer device;

a resolution parameter describing a resolution of a printed image; and

a print quality parameter describing a print quality of an image.

According to a third aspect of the present invention there is provided a format for a print data file, said print data file comprising:

an image data content field, capable of containing data describing an image to be printed; and

a job ticket field said job ticket field containing at least one setting flag for setting when a calibration operation of said printer device occurs.

According to a fourth aspect of the present invention there is provided a method of operating a printer entity, for applying automatic calibration of said printer entity, said method comprising the steps of:

receiving a job description file, said job description file comprising data specifying a first set of set up parameters of said printer entity;

for each of said plurality of set up parameters of said job description file, reading a corresponding set up parameter in operation at said printer entity, to obtain a set of set up parameters;

comparing said first set of set up parameters read from said job description file with said second set of set up parameters in operation at said printer entity;

if said first set of parameters read from said job description file differ from said second set of parameters in operation at said printer entity outside pre-determined limits, then initiating a color calibration procedure at said printer entity.

According to a fifth aspect of the present invention there is provided a printer entity configured for applying an automatic self calibration, said printer entity comprising components for:

receiving a job description file, said job description file comprising data specifying a first set of set up parameters of said printer entity;

for each of said first set of set up parameters of said job description file, reading a corresponding set up parameter in operation at said printer entity, to obtain a second set of set up parameters;

comparing said first set of set up parameters read from said job description file with said second set of set up parameters in operation at said printer entity;

if said first set of parameters read from said job description file differ from said second set of parameters in operation at said printer entity outside pre-determined limits, then initiating a color calibration procedure at said printer entity.

According to a sixth aspect of the present invention there is provided a remote calibration method for calibrating a remote printer entity, said remote calibration method comprising:

generating a job description file containing at least one flag for instructing a calibration procedure;

sending said job description file to said remote printer entity; and

at said remote printer entity, reading said flag, and initiating a color calibration procedure in response to a condition of said flag.

According to a seventh aspect of the present invention there is provided a format for a print data file, said print data file comprising:

an image data content field, capable of containing data describing an image to be printed; and

a job ticket field said job ticket field containing data describing color calibration conditions which a printer device must meet, in order to perform a print operation.

Other aspects of the invention are as recited in the claims herein.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 illustrates schematically a prior art printer device, with associated host computer for driving the printer device, wherein the printer device operates a prior art closed loop color calibration method;

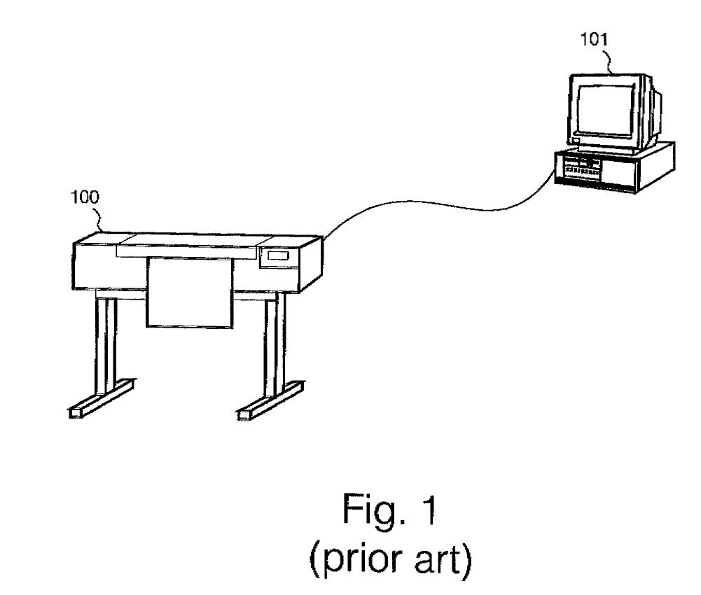

FIG. 2 illustrates schematically prior art signal processing implemented in the printer device, for applying calibration values to a received image data, to produce a corrected image data according to a set of calibration values;

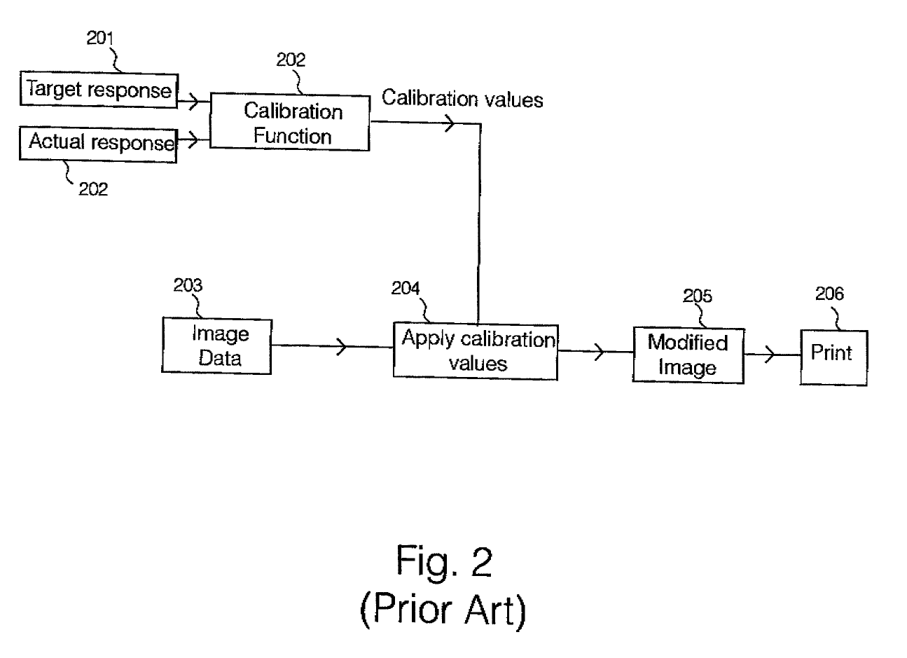

FIG. 3 illustrates schematically a remote proofing system, comprising at least one originating computer for originating a print job, optionally a routing computer entity, for routing a print job over a communications network, and at least one printer entity, comprising a printer device and, optionally, a host computer device to which the printer device may be attached as a peripheral device, for fulfilling printing of an image according to a received print job;

FIG. 4 illustrates schematically one implementation of a printer entity, comprising a printer device and a host computer, to which the printer device is attached as a peripheral device, the printer entity operating a calibration procedure according to a specific implementation of the present invention;

FIG. 5 illustrates schematically a job description file sent by a producer entity, containing proofing data;

FIG. 6 illustrates schematically a process carried out by a printer entity, for determining whether a calibration process needs to be activated on receipt of a job description file as illustrated in FIG. 5 herein;

FIG. 7 illustrates schematically a closed loop color calibration checking procedure implemented at the printer entity on receipt of a job description file;

FIG. 8 illustrates schematically a logical view of work flow from one or more originating entities to one or more printer entities, via one or more router entities, according to a remote proofing method;

FIG. 9 illustrates schematically a job ticket data, comprising a plurality of data fields for use in a remote calibration procedure;

FIG. 10 illustrates schematically process steps carried out for checking a print head of a printer device;

FIG. 11 illustrates schematically process steps carried out for checking ink levels of a printer device;

FIG. 12 illustrates schematically process steps carried out for checking environmental conditions for a printer device; and

FIG. 13 illustrates schematically a calibration mode of a printer entity comprising a printer device, for remote calibration of the printer device;

### DETAILED DESCRIPTION OF THE BEST MODE FOR CARRYING OUT THE INVENTION

There will now be described by way of example the best mode contemplated by the inventors for carrying out the invention. In the following description numerous specific details are set forth in order to provide a thorough understanding of the present invention. It will be apparent however, to one skilled in the art, that the present invention may be practiced without limitation to these specific details. In other instances, well known methods and structures have not been described in detail so as not to unnecessarily obscure the present invention.

In the best mode implementation, in a remote proofing system, certain print jobs may require an accurate and up-to-date set of calibration values for printing. A calibration request is added into a job ticket of a print job sent to a remote printer. The printer checks if its current calibration values are accurate and up-to-date by checking conditions of the printer and of the environment in which the printer is placed. If the calibration values are not up-to-date, the printer runs a fresh closed loop color calibration process before printing a proof.

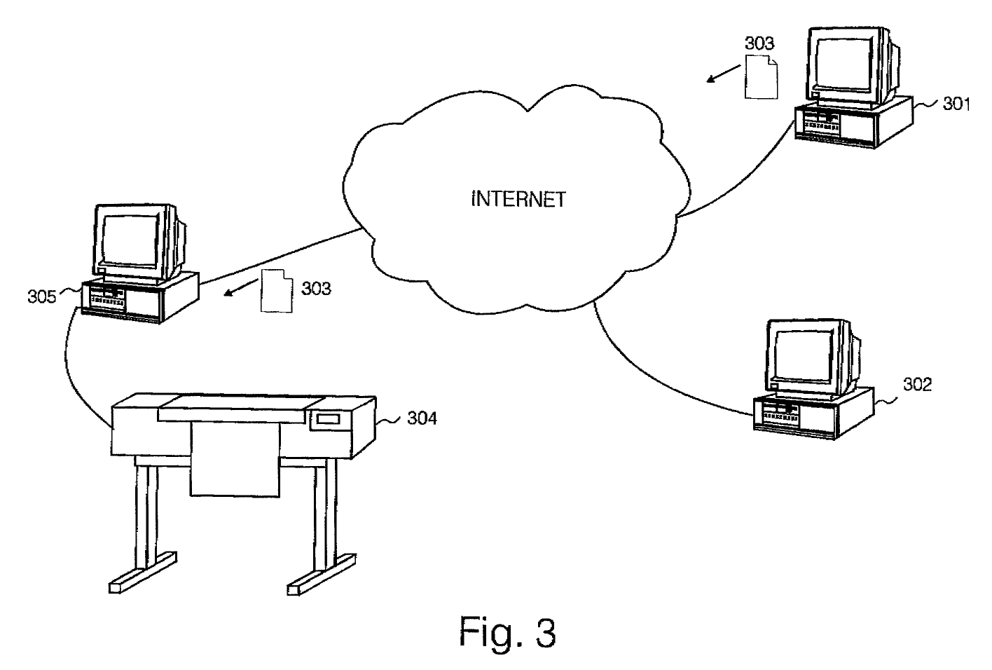

Referring to FIG. 3 herein, there is illustrated schematically a remote proofing system, whereby a printer entity 300 is capable of receiving print jobs remotely from one or a plurality of print job originating computer entities 301, either directly over a communications network, for example the internet or a wide area network, or via an intermediate computer 302 which routes the print job to the printer entity. A job description file 303 is generated by the originating computer 301 and received by the printer entity 300 directly, or via intermediate computer 302. The printer entity 300 comprises at least one printer device 304 which may be connected directly to the internet, and optionally, a print manager computer 305, to which the printer device 304 may be attached as a peripheral device.

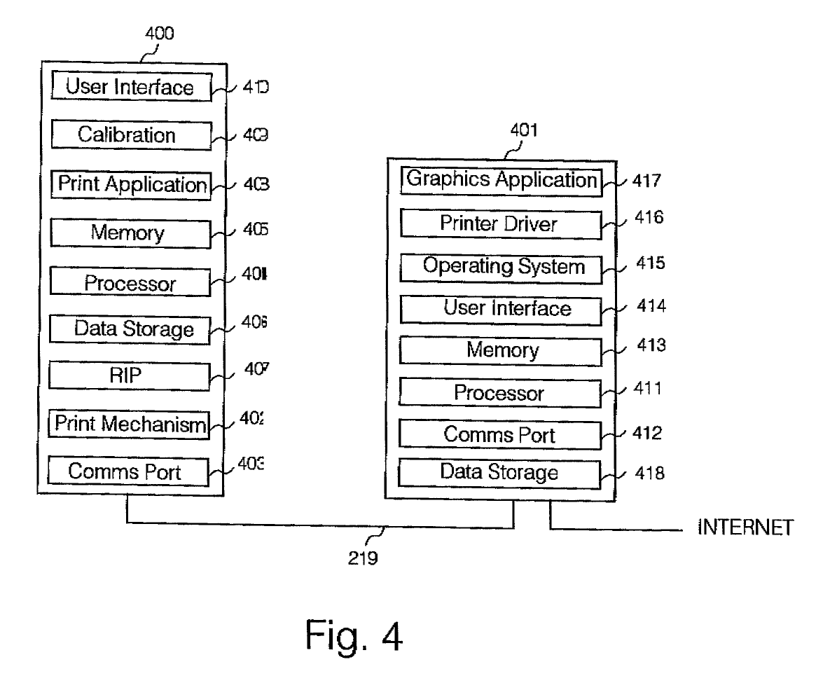

Referring to FIG. 4 herein, there is illustrated schematically components of the printer device 400 and print manager computer 401 of FIG. 3. The printer device 400 comprises a printer mechanism 402 for handling print media, and including a print head for printing inks onto a print media; a communications port 403 for communicating with an external source of print data, for example, print manager computer 401; a data processor 404; a memory device 405; a data storage device 406 for temporarily storing files to be printed; a raster image processor 407 for raster image processing an image file prior to printing; one or more print applications 408 for controlling the printer; a calibration component 409 for applying calibration of ink tones and colors and a user interface 410, for example a liquid crystal display (LCD) and keypad interface, for displaying to a user a status of the printer device, and for allowing calibration of the printer device through one or more menu displays. The interface 410 may also include a web interface.

Print manager computer 401, comprises a processor 411, for example an Intel®, or similar processor; a data storage device 412, such as a hard disk drive; a volatile memory device 413, e.g. RAM; a user interface 414, comprising a visual display device, a keyboard, and a pointing device such as a mouse or trackball device; an operating system 415, for example the known Unix®, Linux®, or a Windows NT® operating system; at least one printer driver 416 for driving the printer device 400; one or more graphic applications 417 for generating a print file containing data to be printed by the printer; and at least one communications port 418 for communicating with the printer device 400 over a communications link 419, for example a local area network, Ethernet cable or the like.

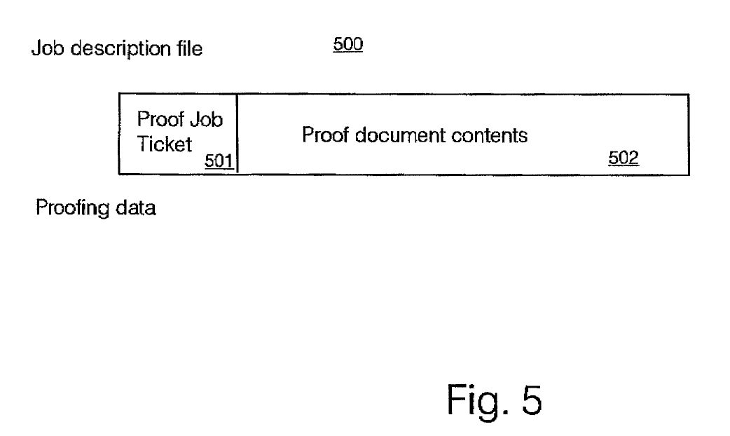

Referring to FIG. 5 herein, there is illustrated schematically a job description file 500, containing enough data to proof a document to be printed on printer device 304, calibrated according to a closed loop color calibration method. The job description file 500 comprises a job ticket data 501 and a proof document content data 502. The job ticket data 501 comprises enough information on how to process the proof document content data 502 to correctly and consistently print a proof on a printer device such as a remote printer device, that supports the remote proofing method disclosed herein. The job ticket data 501 comprises a plurality of settings, from which the printer device can determine whether or not a re-calibration of the printer device is necessary prior to printing a proof document contained or referred to by URL in the proof document content data 502. Where the proof document content data 502 is empty, the printer device can still read the settings, to determine whether a re-calibration of the printer device is necessary, to generate new printer calibration values or not. The proof document content data 502 contains the actual document to be proofed, described in a standard or proprietary data format and meeting all requirements to facilitate consistent output on different printer devices.

The data in the proof document content 502 and in the job ticket data 501 are complementary to each other. To perform remote proofing, both data items are required in the job description file. To perform a remote calibration procedure, only the content of the job ticket data 501 is necessary.

Operation of a remote proofing service will now be described.

Originating computer 301 sends a job description file either directly to printer device 304 or to print manager computer 305. The job description file may be routed via one or more intermediate computer entities 302. The one or more intermediate computer entities may add various items of data to the job description file, for example specifying a particular media type or the like. The print job description file contains a proofing data, containing all the information required to fulfil a print job by printing an image onto a print media.

To achieve the goal of ensuring that a certain job is processed and printed using an accurate and up to date set of calibration values at the printer device, the print job is marked with a “color calibration required” setting. In a remote proofing system, this color calibration required setting is carried in the job ticket 501 of the job description file.

When the color calibration required setting is identified by the calibration component 409, which may reside either within the printer device, or within the intermediate computer 401, the calibration component checks if it already has stored a set of calibration values which are correct to be used with the current printing conditions experienced by the printer device. If that is not the case, a closed loop color calibration procedure is triggered to compute a new set of calibration values which will be used to render and print the job.

The type of checks and conditions that the calibration values must meet to be considered to be correct, depend upon the characteristics and features of the printer device. In the best mode, the following criteria must be met in order that the calibration values currently in force at the printer device, on receipt of a job description file are satisfactory to continue printing without any re-calibration process being required:

A closed loop color calibration has been performed on the media currently loaded onto the printer device.

A closed loop color calibration has been performed with the current set of print heads loaded onto the printer device.

The print heads currently loaded onto the printer device have not printed more than a specified pre-determined amount of ink after the last calibration which has been performed.

A closed loop color calibration has been performed with environmental conditions, for example temperature and humidity, similar to the environmental conditions currently applied to the printer device.

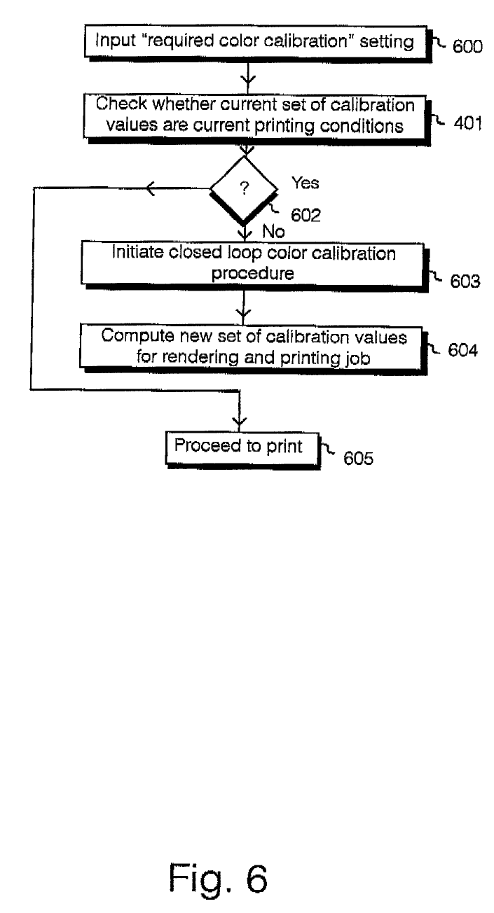

Referring to FIG. 6 of the accompanying drawings, there is illustrated schematically process steps carried out by the printer entity when a job with a color calibration required setting is processed by the calibration component 409. In process 600, when a job description file is received, the calibration component searches within the job ticket 501. The job ticket does not carry calibration values of the printer device, because the originating computer entity has no way of determining the current calibration values in force at the particular printer device which will fulfill the print job. Rather, the job ticket carries a set of “settings”, being conditions that the calibration in the printer must meet, for example which media type is loaded into the printer, the print quality settings at the printer, a time since last calibration. If those conditions are not met, then a re-calibration may be initiated by the printer device. In process 601, the calibration component reads current settings of data stored at the printer device describing a set of operating conditions currently operated by the printer device, and compares these with the color calibration settings received from the job description file of the print job which has been received from the originating computer 301. If, in step 602, the first set of calibration settings in the received job description file correspond to color calibration settings currently operating on the printer device, then in process 605 the job proceeds to print without re-calibration and without generating a new set of calibration values, and the print mechanism of the printer is activated to produce posters or other print items as specified in the job description file. However, if in step 602 the calibration settings in the job description file are not the same as those settings currently in operation on the printer device, then in process 603 a closed loop color calibration procedure is initiated, which results in computation of a new set of calibration values for rendering and printing of the print job contained in the job description file in step 604.

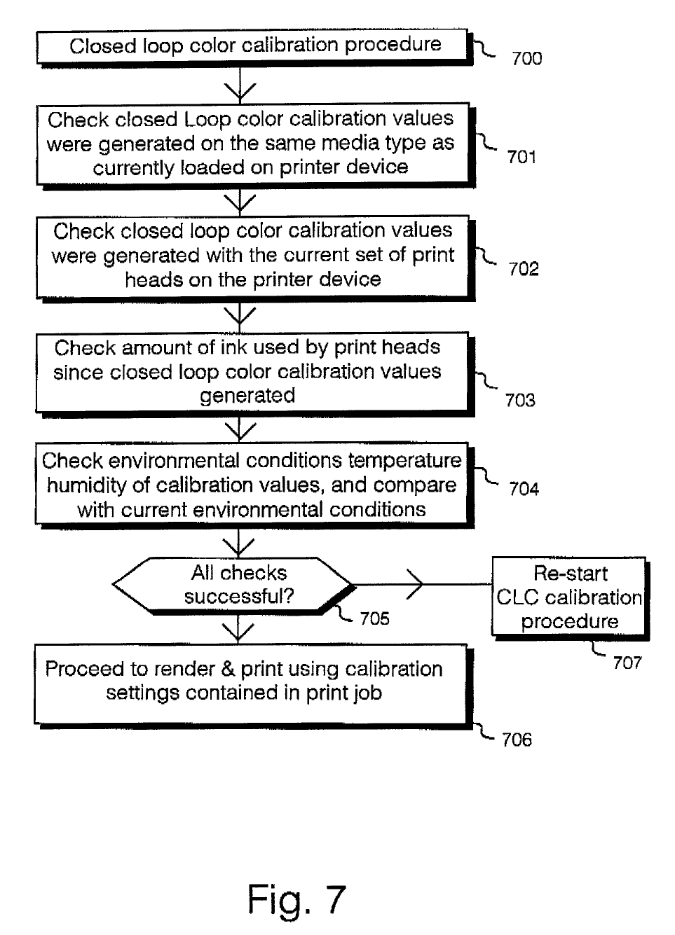

Referring to FIG. 7 herein, there is illustrated schematically process steps carried out by calibration component 409 and printer device 400 to determine whether to implement a closed loop color calibration procedure 700, according to a specific method of the present invention.

In process 701, having read the calibration settings from the received job description file 500, the calibration component checks that the calibration settings contained in the job description file match the same media type as is currently loaded into the printer device. A media type field in the job ticket describes a media type which originating computer 301 specifies usage of. The originating computer may not know the type of media currently loaded onto a printer device. Calibration values are not stored in the job ticket, because the job ticket does not have information concerning the specific characteristics of the printer on which a print job will be printed. The job ticket sets conditions that the calibration values in the receiving printer must meet. In process 702, the calibration component checks that the calibration settings in the job description file were generated with a current set of print heads installed on the printer device. In step 703 it is checked whether an amount of ink used by the print heads currently installed in the printer device since the printer's current calibration values were generated, exceeds a pre-determined value. In step 704, environmental conditions in the immediate vicinity of the printer are checked and are compared with the environmental conditions under which the current calibration values in the printer device were generated. Environmental conditions may include for example temperature and humidity. If all the checks are successful, in step 705, then in step 706 the printer device proceeds to render and print a print job using the current calibration values in force at the printer device immediately before the job description file was received. However, if any of the above tests show that a condition has changed, then a closed loop color calibration procedure is activated in step 707, to generate new calibration values.

There will now be described a job description file data format used to exchange data between computer entities, in a remote proofing system. According to the format of the best mode implementation, there are three types of entity as follows:

Producers/generators: these are applications or modules which can generate proofing data, and are generally resident at originating computers;

Consumers: these are applications or modules which use proofing data to be printed on a proofer or to be viewed on a display. Consumers are typically resident at printer entities.

Routing Services: these are a combination of applications and/or modules which move proofing data in order to forward it from one or more producers to one or more consumers.

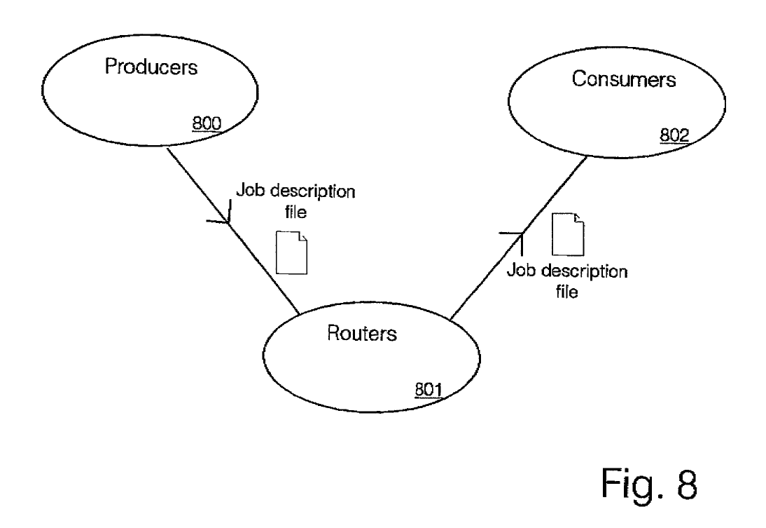

Referring to FIG. 8 herein, there is illustrated schematically a logical work flow for passage of a job between one or more producers 800 and one or more consumers 802 via one or more routers 801. Each logical entity in FIG. 8 may be implemented as code in an application loaded onto a computer entity, written in a known programming language, for example C, C++, or the like, or may be implemented as firmware. An application or item of firmware, may act as producer, router or consumer, or a single application may have modules enabling it to act as a producer, router or consumer. Although the functions may be written in a single application, they can be viewed logically as separate functions as shown in FIG. 8.

A print job produced by a producer is routed via a router to one or more consumers 802. A routing entity may add information to a job description file in order to send the job description from a producer to a consumer, but the changes added by the routing service should be transparent in terms of the general data format used. That is, the data in and data out of the routing service should be compliant with the general format of the job description file.

The job description file contains information on the contents of each page of print in the proof document content data 502, and contains layout information describing an imposition scheme to be used to print the document on a printer device. The layout information is contained in the job ticket 501.

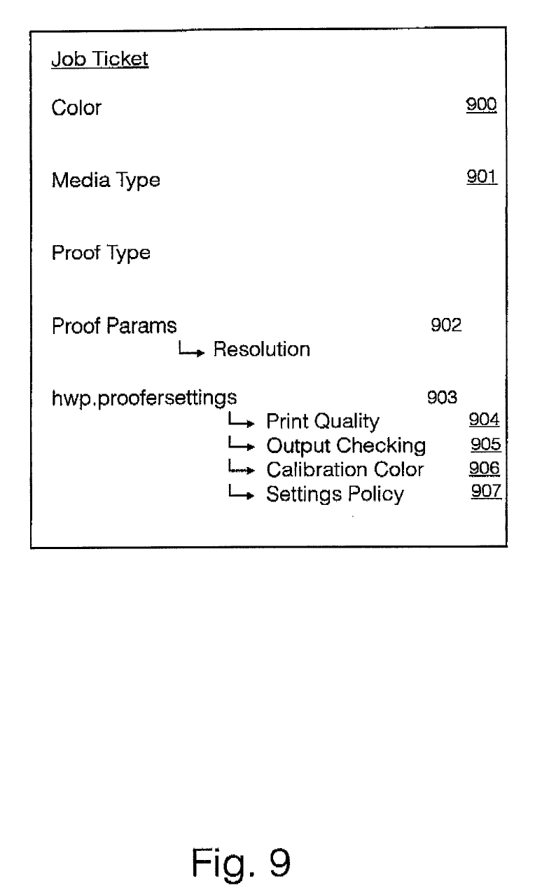

Referring to FIG. 9 there is illustrated schematically a set of data fields comprising job ticket 501, which are referred to by the print entity prior to printing a print job and include a field to determine whether the print job can be printed immediately, without re-calibration of the printer, or whether a calibration of the printer device needs to occur. The fields include the following:

A color field 900: A color space used for the print job is fully defined using an ICC profile. Parameters used to convert from the defined ICC profile color space to a color space of the printer device depend upon the specific printer device, media type and print quality, and are pre-stored by the printer device.

A media type field 901: The media type data field describes the preferred media to be used, and its dimensions. The media type field can be compared to a current print mode of a printer device, and can be used to set a print mode of a printer device.

A proofing parameter field (ProofingParams) 902: This field describes general parameters required to produce a print proof of a print job. Within the proofing parameters field is a resolution field. The resolution field specifies the resolution at which the print should be rendered. In the best mode implementation supported resolutions are 150×150; 300×300; 600×600; and 1200×1200 dpi.

An HWP:ProoferSettings field 903: This field contains specific settings which have to be used to print a proof. Because the remote proofing service is designed to support different printer models, there can be specific settings for different printer models within the hwp:ProoferSettings field. In the best mode implementation, examples of settings are as follows:

HP Designjet 10/20/50 printer models: the printer settings are:

Print quality 904: a number between 0 and 100 which specifies a print quality that has to be used to print the proof. The default value is 100

Color calibration required 906: This is a true/false flag used by the printer entity to determine if calibration needs to be carried out before printing. If set to true, before printing a proof a closed loop color calibration must be carried out by the printer device. The default value is false.

Settings policy 907: This is a flag which can be set to conditions of “override”, on to a “check” condition. If set to override, a media type and print quality specified in the job ticket are used to print the proof regardless of the current printer settings. If set to check, the system checks whether the media type loaded in the printer is the same as the one requested in the job ticket. The default setting is check.

An example of items of a job ticket for a PDF (portable document format) file is as follows (in the example the PDF file, encoded in base 64 is not shown):

MIME-Version: 1.0
Content-Type: multipart/related; boundary=abcdefg0123456789
--abcdefg0123456789
Content-Type: text/xml
<?xml version=‘1.0’ encoding=‘utf-8’ ?>
<JDF ID=“proof1” Type=“Proofing” Status=“waiting” Jobld=“RP0001”>

<NodeInfo/>
<ResourcePool>

<Media ID=“Resource0001” Status=“unavailable”

Type=“Consumable”

Frade=“Mitsubishi Proofing Media” MediaType=“Coated”/>
<ProofingParams ID=“Resource0002” Status=“available”
Type=“Parameter” ProofType=“Contone” Resolution=“600 600”>

<hwp:ProoferSettings hwp:Model=“HP Designjet10/20/50”
hwp:PrintQuality=“100” hwp:OutputChecking=“true”
hwp:CalibratedColor=“true” hwp:SettingsPolicy=“override”/>
</hwp:prooferSettings>

</ProofingParams>
HWEP:PrintQuality=“100/>
<RunList ID=“Resource003” Status=“available” Type=“Parameter”
Npage=“2”#=

<Run Npage=“2”>

<RunSeparation Npage=“2” Separation=“All”>

<LayoutElement Template+“false”
FileSpec+“cid.proof1.pdf”
IsPrintable=“true” ElementType=“document”/>
<RunSeparation>

<Run>

</RunList>

<ResourcePool>
<ResourceLinkPool>

<ConsumableLink rRef=“Resiurce0001” Usage=“input”/>
<ParameterLink rRef=“Resource0002” Usage=“input”/>
<ParameterLink rRef−“Resource0003” Usage=“input”/>

</ResourceLinkPool>

</JDF>
--abcdefg0123456789
Content-Type: application/pdf; name=“proof1.pdf”
Content-Transfer-Encoding:base64
Content-ID:proof1.pdf
BASE64DATA
BASE64DATA
--abcdefg0123456789--

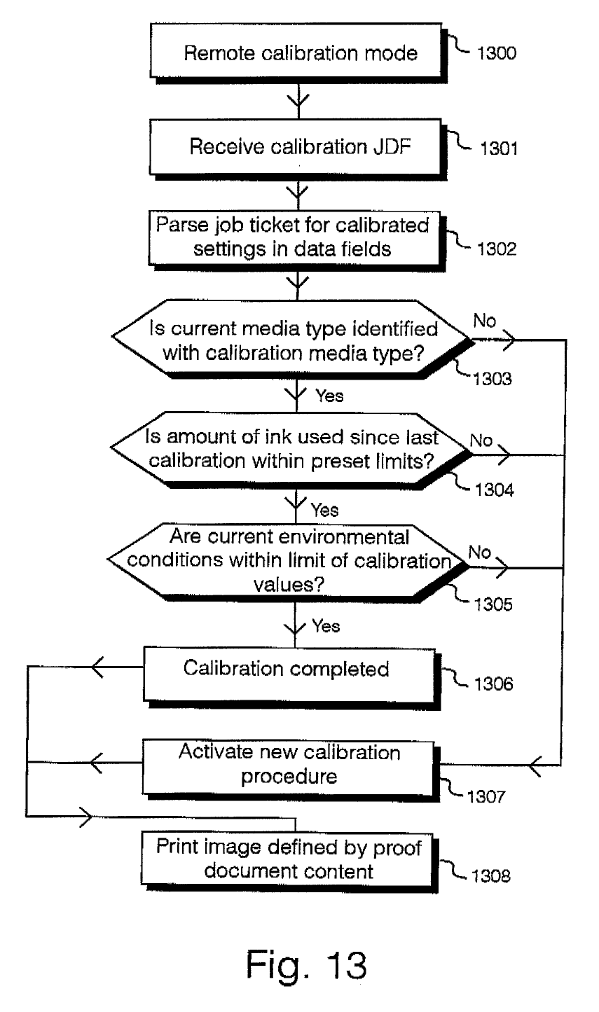

Referring to FIG. 13 herein, there is illustrated schematically process steps carried out by a printer device in a remote calibration mode, in which a job description file containing a job ticket having calibration settings, is received by the printer device. The proof document content data 502 may be empty, or alternatively, could contain a data describing a reference to an image to be printed out eg a URL or the contents data itself. The remote calibration mode 1300 of the printer device commences in step 1301 in which the printer device receives a calibration job description file containing a job ticket having calibration settings. In step 1302, the printer device parses the job ticket for the relevant data fields, automatically as described herein above. In this case, the job ticket contains calibration settings sent by the producer or router. In step 1303, the printer device checks whether the current media type loaded onto the printer device is identical to the calibrated media type defined in the job ticket data fields. If there is a difference between the current media type and that of the defined calibration media type, then in step 1307 a fresh closed loop color calibration procedure is activated resulting in the re-generation of printer calibration values. If the current media type on the printer device is identical with the calibrated media type, then in step 1304 it is checked whether an amount of ink used since a last calibration operation of the printer device is within pre-set limits. The pre-set limits may be stored within the printer device. If an amount of ink larger than the pre-set limit has been used, then in step 1307 a new calibration procedure is activated. However, if the amount of ink used since the last calibration procedure is within the pre-set limit, then in step 1305, it is checked whether the current environmental conditions of the printer are within limits of those defined in the calibration settings in the job ticket. If not, then in step 1307 a new calibration procedure is activated. However, if the current environmental conditions experienced by the printer are within limit of those specified environmental limits in the job ticket, then in step 1306 the calibration procedure is completed, without any re-activation of the closed loop color calibration process being necessary. In step 1308, the content of the proof document content is printed by the printer device. Where the content is blank, no document is printed. However, where there is an image contained in the proof document content or an URL to the file containing an image, this image is printed onto the media type already loaded onto the printer device, giving a visual printed image from the calibrated printer device. The printed image can be visually compared with earlier calibration printed images, to make a visual check that consistency of printed images is obtained from the printer device, by an operator of the printer device. It will be appreciated by the person skilled in the art that the calibration operation can be carried out at the printer device itself, or at the print manager computer 302, to which the printer device may be attached as a peripheral, in which the print manager computer device interrogates the printer device for the ink values and environmental condition readings necessary to implement the efforts described herein.

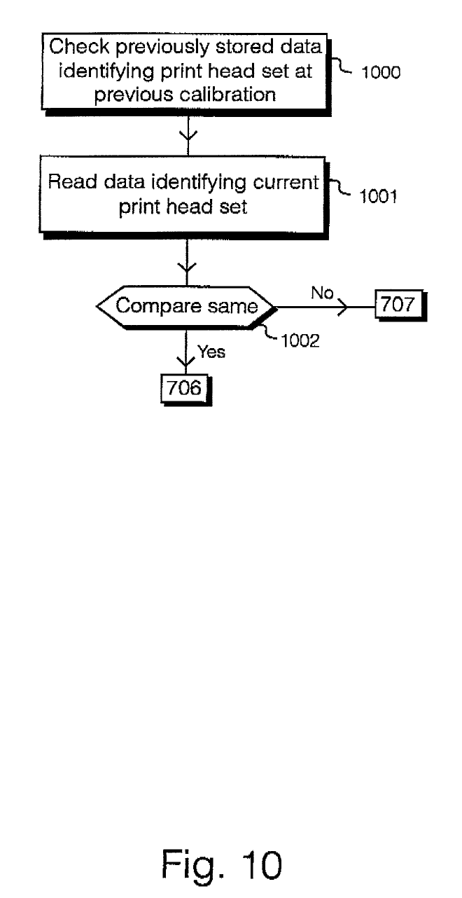

Referring to FIG. 10 here is illustrated schematically process steps carried out for checking the print heads in step 702. In step 1000, when a previous calibration process was carried out, data is stored locally at the printer device, identifying the print head set at the previous calibration. Whenever the print head set is changed, then data describing the new print head set is stored locally in a memory at the printer device. In step 1001, the data identifying the currently installed print head set is read. In step 1002, the data describing the current print head set, and the print head set stored at the previous calibration are compared and if they are the same, then the algorithm proceeds to the next check in step 703. However, if the current print head set is different from the print head set installed at the previous calibration, then a new closed loop calibration procedure is started in step 707.

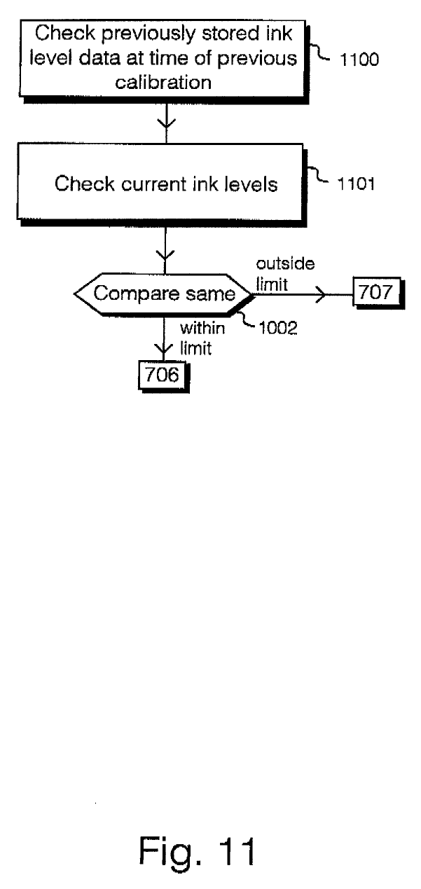

Referring to FIG. 11 herein, there is illustrated schematically process steps carried out to assess an amount of ink used by the print head since a previous closed loop calibration process occurred. In step 1100, it is read from a local memory on the printer device the ink level settings which were stored at a previous calibration operation. In step 1101, the current ink level settings of the current set of inks are read from the print heads. If the current ink level is within a pre-determined limit (for example +/−25%) of the previously stored ink levels at the time of the last calibration, then the algorithm proceeds to the next stage, either of a further check, or of printing an image. However, if the current ink levels are outside limit, then in step 707 a fresh calibration process is commenced.

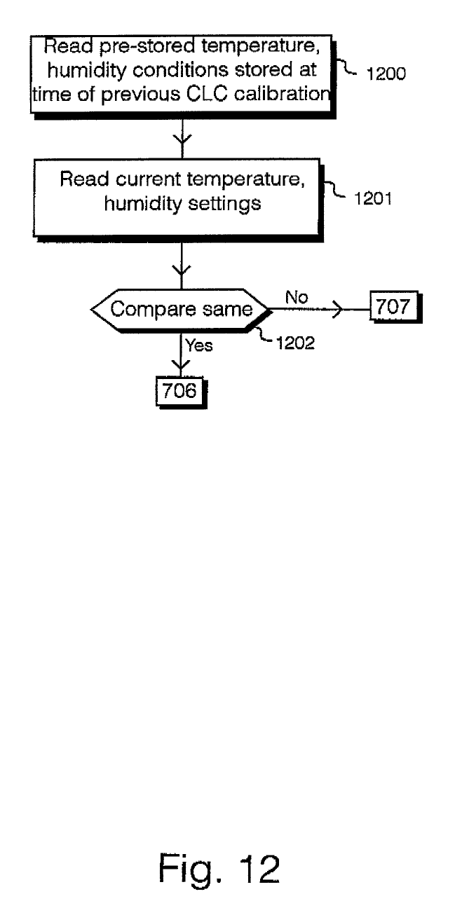

Referring to FIG. 12 herein, there is illustrated schematically process steps carried out in step 704 to check environmental conditions of a printer. Whenever a calibration process is carried out, data describing the environmental conditions of the printer, as read from the temperature sensor and/or humidity sensor, are stored in a local memory of the printer device.

In step 1200, the pre-stored data on the environmental conditions (temperature, humidity) are read from the memory of the printer device. In step 1201, the environmental sensor(s) on the printer device are interrogated, to obtain current values of environmental conditions. If the currently read environmental conditions read from the sensors is within a pre-determined amount (for example +/−5%) of the environmental conditions stored at the previous calibration, then the algorithm proceeds either to a next check, or to step 706 to render and print the image. However, if the current environmental conditions are significantly different (i.e. outside pre-determined limits) of the previously stored environmental conditions, then a re-calibration process is initiated in step 707.

A significant advantage of the specific implementation described herein above may be to provide a method to ensure that print jobs are printed with a correct set of closed loop color calibration values, and ensuring a consistent color behavior of a printer device. This is achieved using a regular printing path of the printer device, by sending the closed loop color calibration requirements in a print job itself, so that no additional communication channels are required to send the closed loop color calibration requirements. This is an advantage when remote printing, for example in the case of an internet based remote printing service, because the same infrastructure used to forward print jobs to a remote printer can also be used to send color calibration settings to the printer. No significant modification of the infrastructure between remotely communicating computers is required, only a modification at a printer device or at a print manager computer, to which the printer device may be attached as a peripheral device.

Further, since the printer is able to handle “empty” (non printing) jobs, which also contain the calibration settings, this enables maintenance of the printer device, that is re-calibration of the printer device, from a remote site.

1. A print job file comprising:
an image data field capable of containing image data describing an image; and
a job ticket field, comprising at least one setting flag for instructing whether a color calibration procedure is to be carried out or not.

2. The print job file as claimed in claim 1, wherein:
said at least one setting flag comprises at least one flag selected from the set:
a color calibration required flag for indicating whether or not a said calibration procedure should be carried out before printing a print job;
an output check flag, for indicating whether or not said calibration procedure should be carried out after printing a print job;
a settings policy flag, for indicating whether to override or check a media type as set on a printer device, prior to printing a print job; and
a settings policy flag for indicating whether to override or check a print quality as set on a printer device prior to printing a print job.

3. The print job file as claimed in claim 1, wherein said image data field contains a URL.

4. The print job file as claimed in claim 1, wherein said image data field is empty of image data.

5. A format for a print data file, said print data file comprising:
an image data content field, capable of containing data describing an image to be printed; and
a job ticket field, said job ticket field containing at least one printer parameter for a printer device, said printer parameter selected from the set:
a media type parameter, describing a type of media installed on said printer device;
a resolution parameter describing a resolution of a printed image; and
a print quality parameter describing a print quality of an image.

6. A format for a print data file, said print data file format comprising:
an image data content field, capable of containing data describing an image to be printed; and
a job ticket field said job ticket field containing at least one setting flag for setting when a calibration operation of said printer device occurs.

7. The print data file format as claimed in claim 6, wherein a said setting flag comprises:
a color calibration required flag describing whether a color calibration procedure is to be carried out by said printer device or not, on receipt of said print data file.

8. The format as claimed in claim 6, wherein a said setting flag comprises:
an output checking flag, indicating whether a proof checking mode should be carried out after a proof has been printed.

9. The format as claimed in claim 6, wherein a said setting flag comprises:
a settings policy flag, said settings policy flag having an “override” condition in which a media type specified in said job ticket are used to print a proof regardless of printer settings, and having a “check” condition, which indicates that a printer entity should check whether a loaded media type is the same as a media type requested in said job ticket field.

10. The format as claimed in claim 6, wherein a said setting flag comprises:
a settings policy flag, said settings policy flag having an “override” condition in which a print quality specified in said job ticket are used to print a proof regardless of printer settings, and having a “check” condition, which indicates that a printer entity should check whether a print quality is the same as a print quality requested in said job ticket field.

11. A method of operating a printer entity, for applying automatic calibration of said printer entity, said method comprising the steps of:
receiving a job description file, said job description file comprising data specifying a first set of set up parameters of said printer entity;
for each of said plurality of set up parameters of said job description file, reading a corresponding set up parameter in operation at said printer entity, to obtain a second set of set up parameters;
comparing said first set of set up parameters read from said job description file with said second set of set up parameters in operation at said printer entity;
if said first set of parameters read from said job description file differ from said second set of parameters in operation at said printer entity outside pre-determined limits, then initiating a color calibration procedure at said printer entity.

12. The method as claimed in claim 11, wherein said step of comparing said set up parameters comprises:
comparing a media type defined in said job description file, with a media type currently installed at said printer entity.

13. The method as claimed in claim 11, wherein said step of comparing said set up parameters comprises:
comparing at least one environmental condition value read from said job description file, with a corresponding environmental condition value currently in operation at said printer entity.

14. The method as claimed in claim 11, further comprising the step of:
reading an amount of ink supply recorded at a previous calibration operation of said printer entity;
reading an amount of ink supply currently at said printer entity;
comparing said previously read amount of ink supply with said current amount of ink supply.

15. The method as claimed in claim 11, wherein:
a said set up parameter comprises a data describing a media type; and
said step of comparing said set up values comprises checking whether said set of calibration values of said printer entity were generated on a same media type as currently loaded on said printer entity.

16. The method as claimed in claim 11, wherein:
a said set up parameter comprises a data describing a print quality; and
said step of comparing said set up values comprises checking whether said set of calibration settings of said printer entity were generated for a same print quality as currently specified in said job description file.

17. A printer entity configured for applying an automatic self calibration, said printer entity comprising components for:
receiving a job description file, said job description file comprising data specifying a first set of set up parameters of said printer entity;
for each of said first set of set up parameters of said job description file, reading a corresponding set up parameter in operation at said printer entity, to obtain a second set of set up parameters;
comparing said first set up parameters read from said job description file with said second set of set up parameters in operation at said printer entity;
if said first set of parameters read from said job description file differ from said second set of parameters in operation at said printer entity outside pre-determined limits, then initiating a color calibration procedure at said printer entity.

18. A remote calibration method for calibrating a remote printer entity, said remote calibration method comprising:
generating a job description file, containing at least one flag for instructing a calibration procedure;
sending said job description file to said remote printer entity; and
at said remote printer entity, reading said flag, and initiating a color calibration procedure in response to a condition of said flag.

19. The remote calibration method as claimed in claim 18, wherein:
said job description file comprises a document content data field for containing data describing a document to be printed.

20. The remote calibration method as claimed in claim 18, wherein:
said job description file comprises a document content data field for containing data describing a document to be printed; and
wherein said document content data is empty.

21. The remote calibration method as claimed in claim 18, wherein:
said job description file comprises a document content data field for containing data describing a document to be printed; and
wherein said document content data comprises a URL address of a file containing a document data.

22. A format for a print data file, said print data file comprising:
an image data content field, capable of containing data describing an image to be printed; and
a job ticket field said job ticket field containing data describing color calibration conditions which a printer device must meet, in order to perform a print operation.

23. The file format as claimed in claim 22, wherein said conditions are selected from the set:
a latest date at which calibration of said printer device has been carried out;
a type of media loaded onto said printer device;
a resolution setting of said printer device;
a print quality parameter of said printer device.
